(19) United States
(12) Patent Application Publication
(10) Pub. No.: US 2009/0271857 A1
(43) Pub. Date: Oct. 29, 2009

(54) METHOD AND APPARATUS FOR FILTERING PACKETS USING AN APPROXIMATE PACKET CLASSIFICATION

(76) Inventors: Jia Wang, Randolph, NJ (US); Suman Banerjee, Madison, WI (US); Qunfeng Dong, Madison, WI (US); Zihui Ge, Waltham, MA (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/109,788

(22) Filed: Apr. 25, 2008

(51) Int. Cl. G06F 21/00; G06F 15/16

(52) U.S. Cl. 726/11

(57) ABSTRACT

A method and apparatus that enables approximate packet classification by using both an exact packet classification method and an inexact packet classification method are disclosed. For example, the method filters a plurality of packets using an exact packet classification method when a processing load is below or equal to a threshold, and filters the plurality of packets by dynamically switching between the exact packet classification method and an inexact packet classification method when the processing load is above the threshold.

The present invention relates generally to communication networks and, more particularly, to a method and apparatus for packet filtering using approximate packet classification in communication networks, e.g., packet networks such as Internet Protocol (IP) networks.

### BACKGROUND OF THE INVENTION

As transmission speeds continue to increase at a faster rate than memory access speeds, software-based classification systems that are used to filter packets are not always able to match the potential rates at which traffic may arrive at the firewalls. Moreover, as more and more complex rules are used to handle increasingly sophisticated attacks, the classification process becomes even slower, thus further hindering the ability of firewalls that use exact packet classification to match such packets at wire speeds. Hence, it is likely that during an overwhelming burst of traffic, the incoming traffic load can exceed the classification capacity of such systems. In such a scenario, incoming packets will have to be delayed in the queue, for longer and longer periods of waiting time. Eventually, the firewall will run out of critical resources such as buffer space, and may start dropping even legitimate packets without getting an opportunity to classify them. A firewall is a dedicated system which inspects and filters network traffic passing through it to permit or deny packet passage based on a set of rules.

### SUMMARY OF THE INVENTION

In one embodiment, the present invention provides a method and apparatus that enables approximate packet classification by using both an exact packet classification method and an inexact packet classification method. For example, the method filters a plurality of packets using an exact packet classification method when a processing load is below or equal to a threshold, and filters the plurality of packets by dynamically switching between the exact packet classification method and an inexact packet classification method when the processing load is above the threshold.

### BRIEF DESCRIPTION OF THE DRAWINGS

The teaching of the present invention can be readily understood by considering the following detailed description in conjunction with the accompanying drawings, in which:

FIG. 1 illustrates an approximate packet classification example of the present invention;

FIG. 2 illustrates an exemplary approximate packet classification framework of the present invention;

FIG. 3 illustrates a flowchart of a method for the adaptation algorithm used by a classifier of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

During the past decade, the Internet has witnessed an escalating demand for protection against unwanted traffic, including those carrying out malicious attacks. To guard against such attacks, enterprises and networks typically construct multiple levels of defense layers consisting of both stateless and stateful components. Stateless approaches are approaches in which the decision to permit or deny a packet depends on the packet itself and no other packet. Although stateless approaches can operate at much higher speeds, they are not as sophisticated in detecting all unwanted traffic. Stateful approaches, though better at detecting sophisticated attacks, cannot match the speeds of stateless filtering.

Both of these techniques are complementary in their use. In general, stateless firewalls can be viewed to be the first layer of a network's defense perimeter. All traffic permitted by a stateless firewall may subsequently be inspected by more stateful approaches. The role of the stateless firewalls is, thus, to reduce the volume of traffic that stateful components have to further inspect and perform complex operations on.

In one embodiment, the present invention focuses on this first layer of a network's defense mechanism, i.e., on the design of stateless firewalls. Stateless firewalls perform packet filtering operations which match each incoming packet against a rule set, e.g., a set of rules defined over the entire packet content. Even though the operations of a stateless firewall are relatively simple, the rules themselves may still require complex functions to be performed on the entire packet, e.g., to evaluate each incoming packet to either permit or deny the packet. For example, a rule might specify a large number of value ranges that will be matched to different components of the packet content. Dependencies may exist between different rules in a rule set such that a packet may match more than one rule. In such cases, there is a strict ordering among the rules and the goal is to find the highest priority matching rule.

Table 1 illustrates a set of exemplary rules that may be used by firewalls.

TABLE 1

```
:rule (
        :source (
                : host_192.168.221.97
                : host_192.168.27.8
                : network_192.168.224.0_255.255.255.0
        )
        :destination (
                : Any
        )
        :services (
                : udp-1433-1434
                : traceroute
                : echo-request
                : ping-replies
        )
        :action (
                : permit
        )
)
:rule (
        :source (
                : Any
        )
        :destination (
                : Any
        )
        :services (
                : Any
        )
        :action (
                : deny
        )
)
```

For a simple illustrating example, consider the rule set in Table 1 and an incoming User Datagram Protocol (UDP) packet, which originates from the source IP address 192.168.224.18, targeting UDP port 1433. This packet matches both the first rule and the second (default deny) rule. It matches the first rule because it comes from the network 192.168.224.0 whose network mask is 255.255.255.0.

Applying the two rules in their given order in Table 1, the first rule determines the fate of the packet and hence the packet is accepted. However, if the ordering of these two rules is reversed, the default deny rule will determine the fate of the packet and hence the packet will be dropped instead. Such and other complexities in the matching process imply that a firewall's packet filtering operations need to be implemented in software.

As transmission speeds continue to increase at a faster rate than memory access speeds, software-based classification systems are not always able to match the potential rates at which traffic may arrive at the firewalls. Moreover, as more and more complex rules are used to handle increasingly sophisticated attacks, the classification process becomes even slower, thus further hindering the ability of firewalls to match such packets at wire speeds. Hence, it is likely that during an overwhelming burst of traffic, the incoming traffic load can exceed the classification capacity of such systems. In such a scenario, incoming packets will have to be delayed in the queue, for longer and longer periods of waiting time. Eventually, the firewall will run out of critical resources such as buffer space, and start dropping even legitimate packets without getting an opportunity to classify them. This is a problem faced by many networks under high traffic loads (including misbehaving users and Denial of Service attacks), and the exploration in this domain was triggered by multiple instances of firewall failures due to such overload. The present invention enables packet filtering strategies in a stateless firewall that minimize the total volume of legitimate traffic that is dropped.

Typical firewalls attempt to perform exact packet classification. Namely, the software filtering process will permit or deny a packet only if it is the correct action according to its rule set. Such packet classification is considered to be semantically-exact. In contrast, in one embodiment, the present invention enables the use of semantically-inexact packet classification, e.g., classification where the firewall's software process may sometimes violate the rule set semantics, and drops some legitimate traffic as well. However, it will never permit unwanted traffic through the firewall. Such inexact classification will be applied only when necessary, i.e., only when the exact classification process is unable to keep up with the incoming traffic volume, will the system switch to the inexact classification. Since the classification is inexact, this approach is called approximate packet classification. As discussed, the approximation is conservative, i.e., no unwanted traffic (as defined by the rule set) is permitted by the firewall, but some legitimate traffic may be dropped during high loads.

In one embodiment, the present invention structures the classification process to meet two goals. The first goal is to minimize the total volume of legitimate traffic that is dropped by the firewall. The secondary goal is to minimize the classification latency for all traffic that is permitted by the firewall.

Note that any exact classification system will also drop some legitimate traffic under heavy loads. This will happen only due to buffer overflows prior to classification. In the approximate approach, some legitimate traffic may be dropped due to the inexact nature of the classification process. Depending on the specific techniques applied, additional legitimate traffic may still be dropped due to buffer overflows. Minimally, it is desired that the aggregate of all such drops of legitimate traffic in the inexact case is lower than the drops in the current model of exact classification.

Table 2 illustrates an exemplary rule set of 4 rules ordered by priority.

TABLE 2

| | |
|---|---|
| Rule I | (F₁ ∈ [10, 70]) [symbol] (F₂ ∈ [40, 65]) → permit |
| Rule II | (F₁ ∈ [20, 85]) [symbol] (F₂ ∈ [20, 60]) → permit |
| Rule III | (F₁ ∈ [25, 75]) [symbol] (F₂ ∈ [55, 85]) → permit |
| Rule IV | (F₁ ∈ [0, 100]) [symbol] (F₂ ∈ [0, 100]) → deny |

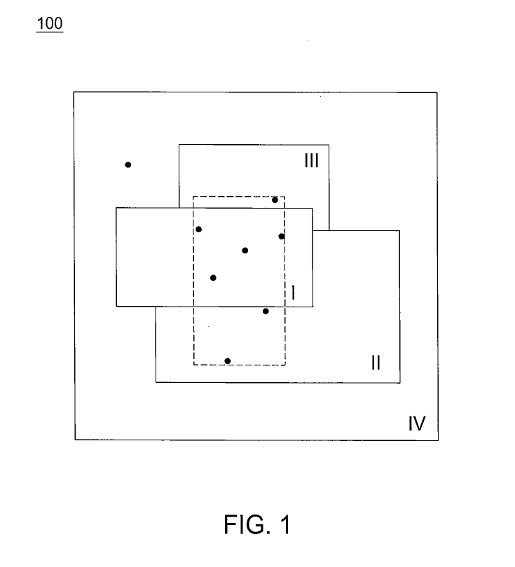

FIG. 1 illustrates an approximate packet classification example 100 of the present invention based on the rule set in Table 2. This approach of approximate packet classification is illustrated using a simple example. Consider the rule set shown in Table 2, which is also pictorially illustrated in FIG. 1. The rule set checks two fields in the incoming packets, denoted by F₁ and F₂.

In FIG. 1, the two fields, F₁ and F₂, are represented along x and y axes, respectively. The boxes correspond to different rules. In particular, the shaded boxes correspond to rules whose decision is permit whereas the white boxes correspond to rules whose decision is deny. In the scenario depicted in FIG. 1, there are 8 flows observed by the firewall, each represented by a corresponding dot. For example, a flow corresponds to a set of all packets with the same projection, and where the projection of a packet is defined as the d-tuple consisting of the values of the d fields specified in the rule set.) Rules I, II, III and IV match 4, 2, 1 and 1 of these 8 flows, respectively. Among these 8 flows, the 7 flows matched by Rules I, II and III are legitimate flows, while the other one flow should be denied.

To provide the basic intuition, a naive packet classification algorithm may compare each incoming packet with every individual rules in order. Moreover, the classification speed of the packet classification algorithm will depend on the number of used rules as well.

Assuming the firewall is capable of comparing a rule with 100 units of traffic per second, and each flow contributes 10 units of traffic per second. Exact classification of the 8 flows requires a classification capacity of comparing a rule with 4×1×10+2×2×10+1×3×10+1×4×10=150 units of traffic per second. Consequently, incoming packets will get delayed in the queue and the firewall will end up dropping one third of incoming legitimate packets. Assuming the queue can accommodate L packets. For those legitimate packets that are not dropped, as the queue is always full, they have to wait for all the L packets already in queue to be classified, before they can be classified. That represents a significant delay for those legitimate packets that will eventually be permitted by the firewall.

The premise of the present approximate packet classification is that if a considerable percentage of legitimate packets can be approved to avoid accumulating packets in the queue, possibly at the cost of mistakenly denying a small percentage of legitimate packets, then the legitimate packet drop rate will be lower than that caused by an exact packet classification method, since the system will not have to drop (possibly a large percentage of) packets due to buffer overflow. Moreover, the average delay on legitimate packets will be much lower than the delay incurred by exact packet classification method.

An approximate packet classification scheme is first considered where the firewall only compares each incoming packet with the first K rules and drops all packets that do not match them. The case when K=2 is examined. Such approximate classification of the 8 flows requires a classification capacity of comparing a rule with 4×1×10+2×2×10+1×2×10+1×2×10=120 units of traffic per second. As a result, the firewall will only need to drop (120−100)/(120)=⅙ of the incoming (legitimate) packets, although the queue is still full and hence the long delay on approved packets remains. It can be verified that K=1 or K=3 will lead to more drops of legitimate traffic than the K=2 case.

However, if a new rule Rule X: (F₁ε[32,55]) ̂(F₂ε[32,68])→permit is constructed as illustrated by the dashed box in FIG. 1, then this single rule will match all 7 legitimate flows and executes the same action. In this case, it only needs to simply compare each incoming packet with this single new rule X, which requires a classification capacity of comparing a rule with 4×1×10+2×1×10+1×1×10+1×1×10=80 units of traffic per second, which is within the firewall's classification capacity. Consequently, the firewall does not have to put packets in the queue or to drop them. The legitimate traffic drop rate and the delay of legitimate traffic both reach zero, in this example of approximate packet classification.

The above example illustrates that under heavy load conditions a careful design of a semantically-inexact classification can actually be better than a semantically-exact classification. In one embodiment, the following requirements are identified for the design of an inexact classification:
The inexact classification should not lead to unnecessary packet drops for legitimate traffic when the incoming volume of traffic is low. In particular, under low loads inexactness would not be useful.
Under high loads, inexact classification should lead to lower drop rate and lower delay for legitimate traffic than exact classification.
No unwanted traffic will be permitted even when inexact classification is in effect.

The approximate packet classification system meets all of these requirements by answering the following specific questions.
When and how to switch between exact and inexact classification schemes? While inexact classification can reduce legitimate packet drop rate under high loads, it should not be used under low loads since it may unnecessarily drop legitimate packets due to its inexact nature.
How to obtain the new rules for further improving classification efficiency?
Which of the new rules and given rules to use for approximate classification of incoming packets?
As incoming traffic pattern changes, how to update the set of rules to be used in the approximate classification scheme?
How to make sure that unwanted packets are never permitted by the firewall?

Content-addressable memory (CAM) is a special type of computer memory used in very high speed searching applications. Unlike standard computer memory, such as random access memory (RAM), in which the user supplies a memory address and the RAM returns the data word stored at that address, a CAM is designed such that the user supplies a data word and the CAM searches its entire memory to see if that data word is stored anywhere in it. Binary CAM is the simplest type of CAM which uses data search words comprised entirely of 1s and 0s. Ternary CAM allows a third matching state of “X” or “Don't Care” for one or more bits in the stored data word, thus adding flexibility to the search.

This solution, however, still gets overloaded when large bursts of traffic arise. In one embodiment of the present invention, a systematic approach to implementing inexact classification is introduced such that it achieves the desired performance objectives for firewalls. Through comparisons, using real traffic traces and real rule sets from a tier-1 Internet Service Provider (ISP), it is shown that the inexact classification scheme leads to significant performance gains (both in terms of latency and drop rate for legitimate traffic) over the exact classification scheme, especially under high loads. In particular, the present invention can reduce legitimate packet drop rate by as much as an order of magnitude, and reduce packet delay by as much as a factor of 4. When the incoming traffic load is low, the present invention seamlessly converges to exact classification and hence avoids unnecessary drops of legitimate packets under low loads.

The design for approximate packet classification to improve robustness of stateless firewalls is now described. Starting with the observation that most rule sets have significant redundancy in their rules. In particular, different firewall rules may get added at different points in time, possibly triggered by different sources of reported vulnerabilities. It is possible that a newly added rule is partially, or even completely, covered by other rules. Hence, the first step in designing a system is to eliminate such redundancies, by transforming a specified rule set into a new rule set that is semantically equivalent, i.e., the classification decision of the new rule set is identical to the original rule set. For example, the new rule set is just a more efficient version of the original rule set for exact packet classification. In turn, in a second step, an approximate classifier based is built on the new rule set, by carefully introducing inexactness during periods of high loads in lieu of faster classification speeds.

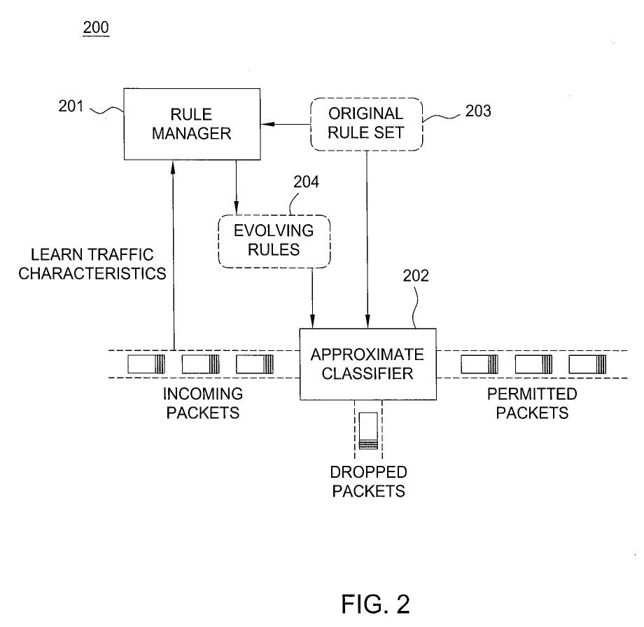

The design of the approximate classification system, therefore, consists of two components: a rule manager and an approximate classifier as shown in FIG. 2. FIG. 2 illustrates an exemplary approximate packet classification framework 200 of the present invention. The rule manager (e.g., an exact classifier) 210 is responsible for the first step, while the approximate classifier 202 is responsible for the second step. In particular, the approximate classifier 202 tries to classify incoming packets in an adaptive and not necessarily exact manner, using a certain subset of the rules provided by the rule manager 201 as well as the original rule set 203. It adapts its choice of this subset in response to changes in the incoming traffic. In the present invention, a rule manager that guarantees exact classification selected from prior best known schemes is selected, and its characteristics are summarized in the following section.

To build an efficient rule set, the rule manager continuously samples incoming traffic and computes specific statistics of this sampled traffic to learn its current characteristics. In particular, the rule manager calculates all distinct sampled flows and their frequency (which is referred to as weight) in the sample. Based on this sampled information, the rule manager 201 creates and maintains a small set of new rules that cover all sampled packets, and dynamically evolve these rules in response to traffic pattern changes. They are called evolving rules 204. The created evolving rules 204 will likely match a significant portion of incoming traffic and hence can be effectively used later for improving the efficiency of both exact classification and inexact classification. These evolving rules possess the following properties:
Each evolving rule is semantically consistent with the original rule set. Namely, if an evolving rule matches a packet, its decision (on that packet) is always the same as the decision specified by the original rule set.
The packets of each distinct sampled flow always get assigned to one evolving rule that matches it. This ensures the evolving rules contain the entire sampled information. The weight of each evolving rule is defined to be the total weight of its assigned flows, i.e., the total number of assigned sample packets. After normalization, the normalized weight of an evolving rule is an estimate of the percentage of incoming packets that will be matched by this rule. The approximate classifier tries to adopt an appropriate classification strategy based on this estimation.
The evolving rules are structured in a way such that if two rules match the same packet, they must have the same decision. This simplifies the approximate packet classification, because this allows the use of the evolving rules in any order for approximate packet classification.

The design of the approximate classifier is now described, which classifies incoming packets in a way that adapts to incoming traffic. Suppose there are L evolving rules, R₁, R₂, . . . , Rₗ, provided by the rule manager. Let w₁, w₂, . . . , wₗ denote their normalized weight, respectively. Namely, wᵢ is the percentage of sampled packets that are assigned to Rᵢ. The approximate classifier employs a combination of two classification schemes, the exact packet classification method and the inexact packet classification method, and carefully switches between these two schemes depending on the dynamics of incoming traffic load as discussed below.

An exact packet classification method matches each incoming packet against a certain small number (denoted by m) of evolving rules provided by the rule manager, using some packet classification algorithm A₀. If a matching rule is not found, the packet can be matched against the original rule set (which contains n rules), using some other packet classification algorithm A.

This two stage classification process is intentionally used based on the following observations. Typical rule sets in firewalls being considered have the order of 10⁴ to 10⁵ rules. However, in normal operations, it has been reported that a large volume of the traffic often match just a few rules. Employing a single stage classification process over the entire rule set to find such a match can therefore be much less efficient, even if the best known classification algorithm is applied. Instead, if a small number (say, m<10) of popular evolving rules can be selected, even a simple sequential search approach (used as algorithm A₀) will deliver much higher performance. On failure, the packet can then be compared against the entire rule set using more sophisticated techniques applicable for large rule sets.

It is worth emphasizing that there is no need to make any assumption about A₀ and A. As an initial example for demonstrating the effectiveness and potential of approximate packet classification, simply take a naive sequential search as the algorithm to use as A₀. Because the rule manager typically provides a very small number of evolving rules that are highly popular, employing sophisticated classification algorithms using these evolving rules can only generate very marginal efficiency improvement. Moreover, as the evolving rules are frequently updated (i.e., evolved) by the rule manager, sophisticated algorithms typically have to re-compute sophisticated data structures upon every update by the rule manager. The added overhead may exceed the marginal performance gain.

To perform sequential search (algorithm A₀) through the evolving rules, the evolving rules in a list L is searched (in some order that will be discussed below). Note that simply searching through the entire list of l evolving rules does not necessarily lead to optimal performance. Instead, each incoming packet with the first m evolving rules in L, where m≦l should be carefully compared.

To determine the optimal value of m, suppose the evolving rules are indexed based on their position in L. The estimated workload when using the first m evolving rules is equal to comparing each incoming packet with an average of:

$${N}_{1} ( m ) = ( {\sum }_{k = 1}^{m} {w}_{k} k ) + ( m + W ( n ) ) ( 1 - {\sum }_{k = 1}^{m} {w}_{i} )$$

rules, where W(n) denotes the average number of comparisons per packet incurred by the complete packet classification algorithm A using the original rule set (containing n rules). Here, no assumption about W(n) needs to be made. The firewall can use any complete classification algorithm A applicable for large rule sets. Note that if m=0, the exact packet classification method is reduced to the original single stage packet classification scheme used by the firewall.

The firewall's classification capacity enables it to perform an average of C comparisons for each incoming packet. In general, there are two cases where an incoming packet may be dropped:
Before an incoming packet enters the queue, the packet may be directly dropped without classification, due to a full queue in the case of system overload. Such drops are referred as pre-queuing drops.
After an incoming packet enters the queue, the packet may be dropped according to a classification decision. Such drops are called post-queuing drops.

In the exact packet classification method, there is no post-queuing drop of legitimate packets, because queued packets are always correctly classified. However, incoming legitimate packets may be dropped due to system overload (i.e., pre-queuing drop). Therefore,

If N₁(m)≦C, the firewall is able to handle the incoming traffic load and hence does not have to drop (legitimate) packets.

If N₁(m)>C, the firewall is only able to handle C/N₁(m) of incoming traffic and hence the estimated pre-queuing packet drop rate is 1−C/N₁(m). Since packets are dropped without classification here, it is assumed that such pre-queuing drops are completely random. Thus, legitimate packets are dropped with the same probability ρ=1−C/N₁(m).

In both cases, the goal is to minimize N₁(m) in order to minimize ρ. Thus in L, the evolving rules should be sorted in non-increasing order of weight. (Because m+W(n)>k for any k≦m.) An optimal value of m that minimizes N₁(m) can be determined by checking all possible values of mε[0, 1]. The calculations can be done quite efficiently, especially given the fact that l is typically very small.

Compared with the exact packet classification method, the inexact packet classification method is even more aggressive. In the inexact packet classification method, if a matching rule is not found among the evolving rules, it simply drops the packet without further classifying it using the original rule set, which introduces inexactness for decreased workload and hence much better efficiency.

In this scheme, incoming packets against the first m evolving rules in L, using sequential search are also matched. However, the way the list L and the value of m is determined is different from the exact packet classification method. The estimated workload is equal to comparing each incoming packet with an average of:

$${N}_{2} ( m ) = ( {\sum }_{k = 1}^{m} {kw}_{k} ) + m ( 1 - {\sum }_{k = 1}^{m} {w}_{i} )$$

rules. Compared with the exact packet classification method, the inexact packet classification method is less likely to drop packets due to overload (i.e., pre-queuing drops), since the incurred workload is much lower. But it may drop packets due to mistaken classification decisions (i.e., post-queuing drops), due to its inexactness.

For ease of presentation, the notion of positive weight (denoted by wᵢ⁺ for each evolving rule Rᵢ. If the decision of Rᵢ is permit, then wᵢ⁺=wᵢ and Rᵢ is referred to as a positive rule; If the decision of Rᵢis deny, then wᵢ+=0 and Rᵢ is referred to as a negative rule.
If N₂(m)≦C, the firewall is able to handle the incoming traffic load and packets are only dropped as a classification decision. Thus, the estimated legitimate packet drop rate is given by:

$$ρ = \frac{{\sum }_{k = m + 1}^{l} {w}_{k}^{+}}{{\sum }_{k = 1}^{l} {w}_{k}^{+}}$$

If N₂(m)>C, firewall is only able to handle C/N₂(m) of incoming traffic. The estimated percentage of (legitimate) packets that are dropped before queuing is ρ₁=1−C/N₂(m), and the estimated percentage of legitimate packets that are dropped after queuing is:

$${ρ}_{2} = \frac{C}{{N}_{2} ( m )} \times \frac{{\sum }_{k = m + 1}^{l} {w}_{k}^{+}}{{\sum }_{k = 1}^{l} {w}_{k}^{+}} .$$

The aggregate legitimate packet drop rate ρ is thus given by:

$$\begin{matrix}ρ = ( 1 - \frac{C}{{N}_{2} ( m )} ) + \frac{C}{{N}_{2} ( m )} \times \frac{{\sum }_{k = m + 1}^{l} {w}_{k}^{+}}{{\sum }_{k = 1}^{l} {w}_{k}^{+}} \\ = 1 - \frac{C}{{N}_{2} ( m )} \times \frac{{\sum }_{k = 1}^{m} {w}_{k}^{+}}{{\sum }_{k = 1}^{l} {w}_{k}^{+}}\end{matrix}$$

In both cases, Σ_{K=1}^{m}wₖ⁺ needs to be maximized and N₂(m) needs to be minimized, in order to minimize ρ. Unlike the case in the exact packet classification method, simply sorting the evolving rules in non-increasing order of weight may not minimize ρ here. To determine the optimal list L of evolving rules to be used for approximate packet classification, it is shown that there must exist an optimal list L that satisfies the following properties:

I. The first m evolving rules in L, regardless of their decision, are sorted in non-increasing order of weight. To see that, consider two evolving rules Rᵢ and Rⱼ that both appear in the first m evolving rules of L. Suppose wᵢ<wⱼ and Rᵢ appears before Rⱼ in L. If Rᵢ and Rⱼ is switched, the value of N₂(m) will decrease and the value of Σₖ₌₁^{m}=wₖ⁺ will not change. The value of ρ will decrease.

II. Positive rules in L are sorted in non-increasing order of weight. To see that, consider two positive rules Rᵢ and Rⱼ in L. Suppose wᵢ<wⱼ and Rᵢ appears before Rⱼ in L. If Rᵢ and Rⱼ is switched, the value of N₂(m) will not increase and the value of Σₖ₌₁^{m}wₖ⁺ will not decrease. The value of ρ will not increase.

III. Negative rules in L are also sorted in non-increasing order of weight. To see that, consider two negative rules Rᵢ and Rⱼ in L. Suppose wᵢ<wⱼ and Rᵢ appears before Rⱼ in L. If Rᵢ and Rⱼ is switched, the value of N₂(m) will not increase and the value of Σₖ₌₁^{m}wₖ⁺ will not change. The value of ρ will not increase.

IV. The m-th evolving rule in L should be a positive rule. Otherwise, there is no need to compare incoming packets with the m-th evolving rule, since the packets will be dropped anyway.

By property II, the k highest-weight positive rules are in the first m evolving rules of L is assumed. By property III, the m−k highest-weight negative rules are in the first m evolving rules of L. Then by property I, these first m rules should be sorted in non-increasing order of their weight. Finally, if the m-th rule satisfies property IV is checked. Thus, once k and m are given, an optimal list L can be determined, if such an optimal list L exists for the given k and m at all. That said, an optimal list L can be found after checking all possible values of kε[1,m]. Table 3 illustrates a pseudo code description of the inexact packet classification algorithm of the present invention.

TABLE 3

```
for (m=0; m ≦ I; m++)
    for (k=0; k leq m; k++)
        /* Based on Property II ... */
        if there are less than k positive rules
            continue;
        pick the k highest weight positive rules;
        /* Based on Property III ... */
        if there are less than m−k negative rules
            continue;
        pick the m−k highest weight negative rules;
        /* Based on Property I ... */
        sort the m rules in non-increasing order of weight;
        /* Based on Property IV ... */
        if the m-th rule is a negative rule;
            continue;
        compute ρ for this sorted list L;
        keep the optimal L that minimizes rho so far;
    }
}
```

Given the design and analysis of the exact packet classification method and the inexact packet classification method, an effective method or algorithm for approximate packet classification is now presented. The method dynamically switches between the exact packet classification method (which is exact) and the inexact packet classification method (which is inexact), with preference being given to the exact packet classification method if the packet drop rate is already quite low. Because ideally, if packet drops due to traffic bursts is ignored (much of which is being handled by actively adapting to changes in incoming traffic pattern), the exact packet classification method guarantees correct classification of every incoming packet. In contrast, the inexact packet classification method does not provide such a guarantee.

Initially, the algorithm starts in the exact packet classification method. According to the analysis of the exact packet classification method, the optimal strategy is to choose a value of m such that N₁(m) is minimized. To effectively adapt to incoming traffic load, the pre-queuing drop rate ρ₀ of recently received packets is continuously monitored, and the classification scheme is adapted accordingly.

First, consider the case where the current scheme in use is the exact packet classification method. If ρ does not exceed a threshold (e.g. 3%), which is quite low, then the exact packet classification method continues to be used for classification. Because on the one hand, the legitimate packet drop rate ρ is equal to the pre-queuing drop rate ρ₀ in the exact packet classification method. On the other hand, the inexact packet classification method always has a certain probability of mistakenly dropping legitimate packets, due to its inexact classification of incoming packets. Therefore, continue using the exact packet classification method is a conservative and acceptable choice, especially when the threshold is quite low.

To decide the optimal value of m, the constant C can be estimated in the formula by ρ₀=1−C/N₁(m), which gives C=(1 −ρ₀)N₁(m). The pre-queuing drop rate ρ₀ instead of the drop rate ρ of legitimate packets to estimate C, because calculating ρ₀ does not require knowing if a dropped packet is legitimate or not, which is more realistic. A merit of this approach is that C and ρ₀ are estimated in a real time manner, which provides a dynamic view of the system's currently available capacity and incoming traffic load. Using this estimation, explicit knowledge about currently available system capacity and incoming traffic load is not required, which greatly simplifies the design and implementation of the approximate classification scheme. However, if ρ₀=0, this may underestimate C. Therefore, in such cases there is no need to update the estimation of C. Using the estimated value of C, the optimal value of m can be determined as described in the exact packet classification method section.

If ρ₀ exceeds the threshold (and hence ρ₀>0), there is a need to decide which scheme to use and what the optimal value of m should be. Again, C can be estimated by ρ₀=1−C/N₁(m). After estimating C, a value of m and one of the exact packet classification method and the inexact packet classification method that minimize the drop rate ρ of legitimate packets are chosen. To minimize ρ in the inexact packet classification method, an optimal list L as well as an optimal value of m are computed, as is described in Table 3. If this optimal estimated value of ρ in the inexact packet classification method is lower than the optimal estimated value of ρ in the exact packet classification method, the inexact packet classification method will be used with that m value for approximate packet classification. Otherwise, the exact packet classification method will be used with its optimal m value.

Now the case where the current scheme in use is the inexact packet classification method, is considered. Similarly, the constant C can be estimated by ρ₀=1−C/N₂(m). If ρ₀=0, the estimation of C will not be updated to avoid possible underestimation. Using the estimated value of C, a value of m should be similarly chosen and one of the exact packet classification method and II that minimize the drop rate ρ of legitimate packets, as described above. Table 4 illustrates a pseudo code description of the adaptation algorithm used by the approximate classifier of the present invention.

TABLE 4

```
ChooseScheme;
Exact Packet Classification Method :
      if ρ₀ ≦ threshold) {
          choose Scheme I;
          if (ρ₀ >0)
              C = (1−ρ₀ )N₁(m);
          pick the optimal value of m;
          return;
        }
      if ρ₀ > threshold) {
          if (ρ₀ >0)
              C = (1−ρ₀ ) N₁(m);
          pick the optimal scheme and value of m;
            return;
}
Inexact Packet Classification Method :
      if (ρ₀>0)
          C = (1−ρ₀ ) N₂(m);
      pick the optimal scheme and value of m;
      return;
```

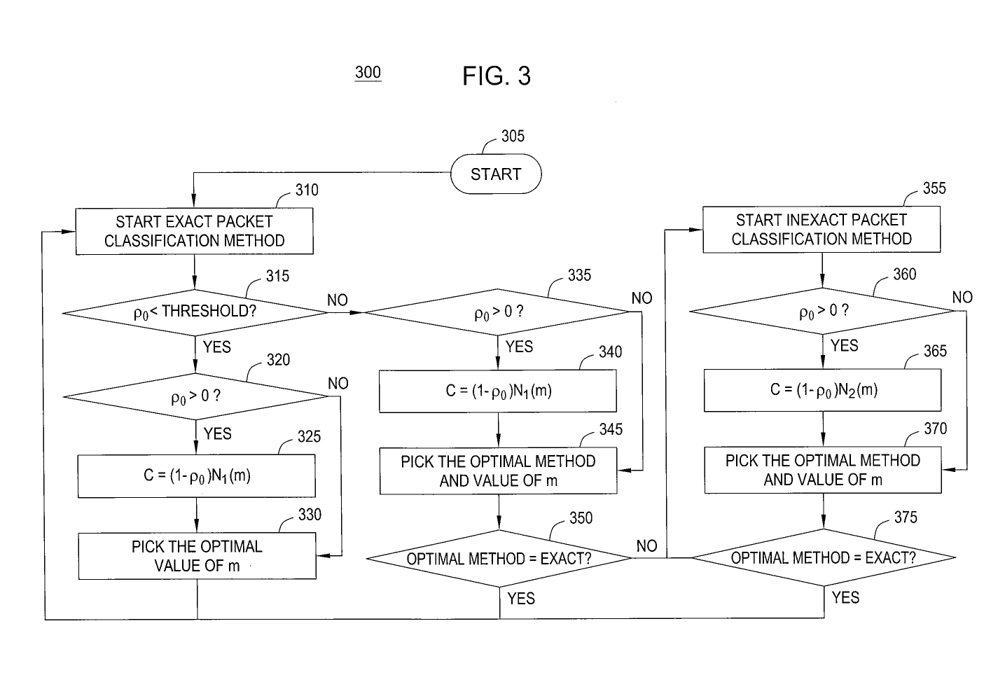

FIG. 3 illustrates a flowchart of a method for the adaptation algorithm used by the approximate classifier of the present invention. Method 300 starts in step 305 and proceeds to step 310.

In step 310, the method proceeds to the beginning of the exact packet classification method. In step 315, the method check if ρ₀≦threshold. If ρ₀≦threshold, the method proceeds to step 320; otherwise, the method proceeds to step 335.

In step 320, the method checks if ρ₀>0. If ρ₀>0, the method proceeds to step 325; otherwise, the method proceeds to step 330.

In step 325, the method sets the value of C to (1−ρ₀)N₁(m).

In step 330, the method picks the optimal value of m and then proceeds back to step 310.

In step 335, the method checks if ρ₀>0. If ρ₀>0, the method proceeds to step 340; otherwise, the method proceeds to step 345.

In step 340, the method sets the value of C to (1−ρ₀)N₁(m).

In step 345, the method picks the optimal packet classification and the value of m.

In step 350, the method checks if the optimal packet classification method is the exact method. If the optimal packet classification method is the exact method, the method proceeds back to step 310; otherwise, the method proceeds to step 355.

In step 355, the method proceeds to the beginning of the inexact packet classification method.

In step 360, the method checks if ρ₀>0. If ρ₀>0, the method proceeds to step 365; otherwise, the method proceeds to step 370.

In step 365, the method sets the value of C to (1−ρ₀)N₂(m).

In step 370, the method picks the optimal packet classification and the value of m.

In step 375, the method checks if the optimal packet classification method is the exact method. If the optimal packet classification method is the exact method, the method proceeds back to step 310; otherwise, the method proceeds to step 355.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

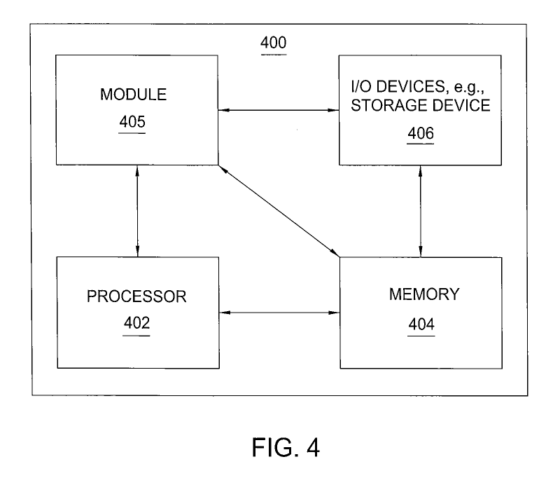

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for packet filtering using approximate packet classification, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for packet filtering using approximate packet classification can be loaded into memory 404 and executed by processor 402 to implement the functions as discussed above. As such, the present process 405 for packet filtering using approximate packet classification (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for filtering packets in a communication network, comprising:
filtering a plurality of packets using an exact packet classification method when a processing load is below or equal to a threshold; and
filtering said plurality of packets by dynamically switching between said exact packet classification method and an inexact packet classification method when said processing load is above said threshold.

2. The method of claim 1, wherein said communication network is an Internet Protocol (IP) network.

3. The method of claim 1, wherein said plurality of packets is a plurality of incoming packets being filtered by a firewall system of said communication network.

4. The method of claim 1, wherein said exact packet classification method comprises:
determining a first m of l firewall evolving rules in a list L dynamically produced by a rule manager using an estimated classification capacity C, where m is an optimal value that minimizes a packet drop rate of legitimate packets, ρ, and m≦l;
using said determined first m rules to filter an incoming packet; and
using all of said l firewall evolving rules to filter said incoming packet if said determined first m rules fail to produce an exact match when processing said incoming packet or if the said determined m has a value of zero.

5. The method of claim 4, wherein said l firewall evolving rules in said list L are sorted in a non-increasing order of weight where said weight denotes a normalized frequency of usage of an evolving rule based on observations on previous packet traffic history.

6. The method of claim 4, wherein said determining said optimal value of m comprises:
estimating said classification capacity, C, using:
C=(1−ρ₀)N₁(m) if ρ₀>0
where ρ₀ is a pre-queueing packet drop rate, and N₁(m) is an estimated workload when using said first m of l firewall evolving rules in said list L;
finding said optimal value of m that minimizes said ρ=1−C/N₁(m) by minimizing the estimated workload when using said first m evolving rules denoted by:
$${N}_{1} ( m ) = ( {\sum }_{k = 1}^{m} {w}_{k} k ) + ( m + W ( n ) ) ( 1 - {\sum }_{k = 1}^{m} {w}_{i} )$$
using said estimated classification capacity, C, where W(n) denotes an average number of comparisons per packet incurred by a complete packet classification method using an original rule set comprising n rules where l ≦n, wᵢ denotes a normalized weight of an evolving rule.

7. The method of claim 1, wherein said inexact packet classification method comprises:
determining a first m of l firewall evolving rules in a list L dynamically produced by a rule manager where m is an optimal value that minimizes a packet drop rate of legitimate packets, ρ, and m≦l;
using said determined first m rules to filter an incoming packet; and
dropping said incoming packet if said determined first m rules fail to produce a match when processing said incoming packet.

8. The method of claim 7, wherein said list L satisfies the following properties:
the first m evolving rules in L, regardless of their decision, are sorted in a non-increasing order of weight, where said weight denotes a normalized frequency of usage of an evolving rule based on observations on previous packet traffic history;
positive rules that permit incoming packets to be forwarded in L are sorted in a non-increasing order of weight, where said weight denotes a normalized frequency of usage of an evolving rule based on observations on previous packet traffic history;
negative rules that deny incoming packets to be forwarded in L are sorted in a non-increasing order of weight, where said weight denotes a normalized frequency of usage of an evolving rule based on observations on previous packet traffic history; and
the m-th evolving rule in L should be a positive rule.

9. The method of claim 7, wherein said determining said optimal value of m comprises:
estimating a classification capacity, C, using:
C=(1−ρ₀)N₂(m) if ρ₀>0
where ρ₀ is a pre-queueing packet drop rate, and N₂(m) is an estimated workload when using said first m of l firewall evolving rules in said list L;
finding said optimal value of m and said list L that minimizes
$$ρ = 1 - \frac{C}{{N}_{2} ( m )} \times \frac{{\sum }_{k = 1}^{m} {w}_{k}^{+}}{{\sum }_{k = 1}^{l} {w}_{k}^{+}}$$
by minimizing the estimated workload when using said first m evolving rules denoted by:
$${N}_{2} ( m ) = ( {\sum }_{k = 1}^{m} {w}_{k} k ) + m ( 1 - {\sum }_{k = 1}^{m} {w}_{i} )$$
and by maximizing a sum of positive weights denoted by:
Σₖ₌₁^{m}wₖ⁺
simultaneously, where wₖ⁺ is a weight of a normalized frequency of usage of an evolving rule based on observations on previous packet traffic history if said rule is a positive rule that permit incoming packets to be forwarded, or wₖ⁺ is zero if said rule is a negative rule that deny incoming packets to be forwarded.

10. The method of claim 1, wherein said dynamic switching comprises:
switching to said exact packet classification method from said inexact packet classification method if a calculated optimal packet drop rate of legitimate packets of said inexact packet classification method is lower than that of said exact packet classification method; and
switching to said inexact packet classification method from said exact packet classification method if a calculated packet drop rate of legitimate packets of said exact packet classification method is lower than that of said exact packet classification method.

11. A computer-readable medium having stored thereon a plurality of instructions, the plurality of instructions including instructions which, when executed by a processor, cause the processor to perform the steps of a method for filtering packets in a communication network, comprising:
filtering a plurality of packets using an exact packet classification method when a processing load is below or equal to a threshold; and
filtering said plurality of packets by dynamically switching between said exact packet classification method and an inexact packet classification method when said processing load is above said threshold.

12. The computer-readable medium of claim 11, wherein said communication network is an Internet Protocol (IP) network.

13. The computer-readable medium of claim 11, wherein said plurality of packets is a plurality of incoming packets being filtered by a firewall system of said communication network.

14. The computer-readable medium of claim 11, wherein said exact packet classification method comprises:
determining a first m of l firewall evolving rules in a list L dynamically produced by a rule manager using an estimated classification capacity C, where m is an optimal value that minimizes a packet drop rate of legitimate packets, ρ, and m≦l;
using said determined first m rules to filter an incoming packet; and
using all of said l firewall evolving rules to filter said incoming packet if said determined first m rules fail to produce an exact match when processing said incoming packet or if the said determined m has a value of zero.

15. The computer-readable medium of claim 14, wherein said l firewall evolving rules in said list L are sorted in a non-increasing order of weight where said weight denotes a normalized frequency of usage of an evolving rule based on observations on previous packet traffic history.

16. The computer-readable medium of claim 14, wherein said determining said optimal value of m comprises:
estimating said classification capacity, C, using:
C=(1−ρ₀)N₁(m) if ρ₀>0
where ρ₀ is a pre-queueing packet drop rate, and N₁(m) is an estimated workload when using said first m of l firewall evolving rules in said list L;
finding said optimal value of m that minimizes said ρ=1−C/N₁(m) by minimizing the estimated workload when using said first m evolving rules denoted by:
$${N}_{1} ( m ) = ( {\sum }_{k = 1}^{m} {w}_{k} k ) + ( m + W ( n ) ) ( 1 - {\sum }_{k = 1}^{m} {w}_{i} )$$
using said estimated classification capacity, C, where W(n) denotes an average number of comparisons per packet incurred by a complete packet classification method using an original rule set comprising n rules where l ≦n, wᵢ denotes a normalized weight of an evolving rule.

17. The computer-readable medium of claim 11, wherein said inexact packet classification method comprises:
determining a first m of l firewall evolving rules in a list L dynamically produced by a rule manager where m is an optimal value that minimizes a packet drop rate of legitimate packets, ρ, and m≦l;
using said determined first m rules to filter an incoming packet; and
dropping said incoming packet if said determined first m rules fail to produce a match when processing said incoming packet.

18. The computer-readable medium of claim 17, wherein said list L satisfies the following properties:
the first m evolving rules in L, regardless of their decision, are sorted in a non-increasing order of weight, where said weight denotes a normalized frequency of usage of an evolving rule based on observations on previous packet traffic history;
positive rules that permit incoming packets to be forwarded in L are sorted in a non-increasing order of weight, where said weight denotes a normalized frequency of usage of an evolving rule based on observations on previous packet traffic history;
negative rules that deny incoming packets to be forwarded in L are sorted in a non-increasing order of weight, where said weight denotes a normalized frequency of usage of an evolving rule based on observations on previous packet traffic history; and
the m-th evolving rule in L should be a positive rule.

19. The computer-readable medium of claim 11, wherein said dynamic switching comprises:
switching to said exact packet classification method from said inexact packet classification method if a calculated optimal packet drop rate of legitimate packets of said inexact packet classification method is lower than that of said exact packet classification method; and
switching to said inexact packet classification method from said exact packet classification method if a calculated packet drop rate of legitimate packets of said exact packet classification method is lower than that of said exact packet classification method.

20. An apparatus for filtering packets in a communication network, comprising:
means for filtering a plurality of packets using an exact packet classification method when a processing load is below or equal to a threshold; and
means for filtering said plurality of packets by dynamically switching between said exact packet classification method and an inexact packet classification method when said processing load is above said threshold.
